(19) United States
(12) Patent Application Publication
(10) Pub. No.: US 2004/0132320 A1
(43) Pub. Date: Jul. 8, 2004

(54) Land grid array connector

(76) Inventor: Larry E. Dittmann, Middletown, PA (US)

Correspondence Address: JoAnn Dilloway, Barley, Snyder, Senft & Cohen, LLC, 126 East King Street, Lancaster, PA, 17602, US

(21) Appl. No.: 10/741,479

(22) Filed: Dec. 19, 2003

Related U.S. Application Data
(60) Provisional application No. 60/435,472, filed on Dec. 20, 2002.

(51) Int. Cl. H01R 12/00

(52) U.S. Cl. 439/66

(57) ABSTRACT

A land grid array connector is provided having a carrier formed with a plurality of contact receiving passageways passing between major surfaces thereof. Each contact receiving passageway is plated over substantially the entire passageway between the two major surfaces. A resilient contact is inserted and frictionally held within each plated contact receiving passageway such that ends of each resilient contact protrude beyond each major surface of the carrier.

### FIELD OF THE INVENTION

The present invention is related to electrical connectors and more particularly to a land grid array connector for connecting two parallel components having an array of contact locations on each.

### BACKGROUND OF THE INVENTION

Land grid array connectors are well known in the electrical connector art and are utilized for interconnecting parallel printed circuit boards or other parallel components. Typically, the parallel components or substrates have a plurality of contact locations known as lands which take the form of a conductive or plated section on the surface of the substrate. The lands are interconnected to traces of a circuit on or within the substrate which are thereafter connected to a plurality of components forming a circuit or system. Land grid array connectors typically feature a plurality of resilient contacts positioned within a substrate wherein the resilient contacts each have terminal ends projecting from opposite sides of the carrier. The land grid array connector is interposed between the two substrates to form an interconnection therebetween. The two substrates are sometimes clamped or otherwise held into position to compress the land grid array connector and associated contacts therebetween.

An example, such a connector is shown in related U.S. Pat. Nos. 5,388,997 and 5,388,998. These patents teach a connection system for interconnecting a pair of rigid circuits to each other. The interconnection system taught by these patents features a plurality of compressive conductive members positioned within a carrier member. The compressive conductive members consist of coil springs having a pair of ends which electrically contact and are compressed between circuits of the pair of rigid circuit members.

A problem exists with connectors in certain medical applications. More specifically, when a connector is utilized within certain medical imaging equipment such as a CT scanner, relatively high voltages may be applied to these connectors during the scanning process. As a result, an electrical potential is generated between each resilient contact and its associated substrate. This electrical potential consists of an electron charge build up between the contact and the or substrate. A physical impact or localized vibration may cause electron mobility at the build up and resultant current across the electron build up region between the contact and the substrate. Such electron mobility results in an electrical spike know as a ping which propagates through the system of a medical imaging apparatus. The ping may cause undesirable image output from the imaging device. Such undesirable output gives false readings in the form of dark spots on the resultant image which could be mistakenly diagnosed as a mass within the body of a patient under the imaging apparatus. It is therefore desirable to eliminate or at least reduce the build up of electrons in these applications in the area of the contact to substrate engagement.

### SUMMARY OF THE INVENTION

It is therefore an object of the present invention to provide an improved land grid array connector wherein electron build up at the location where contacts are held within a carrier is reduced.

This and other objectives are achieved by providing a land grid array connector having a carrier. The carrier is formed with a plurality of contact receiving passageways passing between major surfaces thereof. Each contact receiving passageway is plated over substantially the entire passageway between the two major surfaces. A resilient contact is inserted and makes electrical contact and is held frictionally or may be soldered within each plated contact receiving passageway such that ends of each resilient contact protrude beyond each major surface of the carrier.

### BRIEF DESCRIPTION OF THE DRAWINGS

The invention will now be described by way of example with reference to the accompanying figures of which:

FIG. 1 is a cross sectional view of a carrier for use in the land grid array connector of the present invention.

FIG. 2 is a perspective cut away view of the land grid array connector according to the present invention.

FIG. 3 is a cross sectional view of a land grid array connector having an alternate contact.

### DETAILED DESCRIPTION OF THE INVENTION

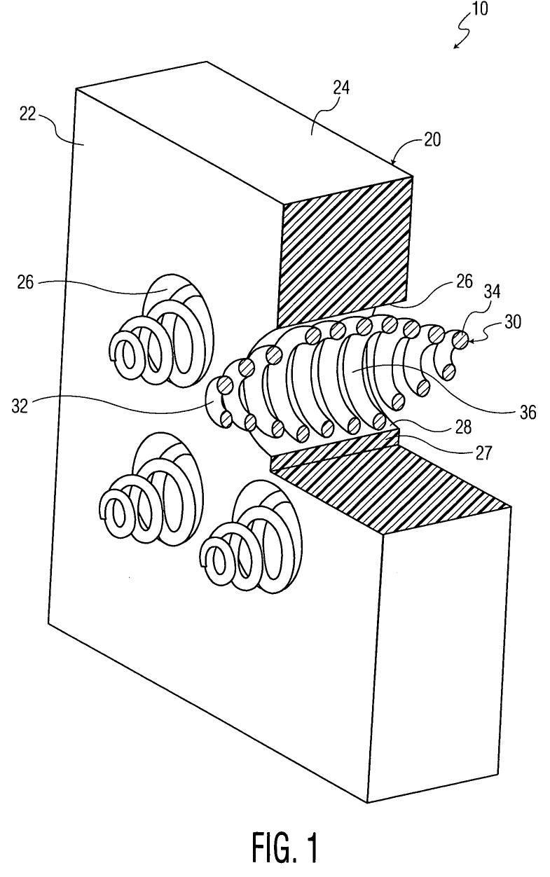

The invention will first be described generally with reference to FIG. 1. The land grid array connector 10 features two major components. First, a carrier 20 is formed of a suitable insulative or semiconductive material having a plurality of contact receiving passageways 26 formed therein. A resilient contact 30 is located within each contact receiving passageway 26.

Each of the major components will now be described in greater detail again with reference to FIG. 1. The carrier 20 features a plurality of contact receiving passageways 26 extending between first and second major surfaces 22, 24. Each contact receiving passageway 26 may be formed as a cylindrical passageway which extends between the first and second major surfaces 22, 24. Optionally, a raised or narrowed engagement section 27 may be formed within the contact receiving passageway 26. At least the engagement section 27 and optionally the entire surface of the contact receiving passageway 26 is plated with a conductive material or series of conductive layers. The plating 28 may extend either over the engagement section 27, along the entire inner surface of the contact receiving passageway 26 and also may extend over portions of the first and second major surfaces 22, 24 in the vicinity of each contact receiving passageway 26. It should be understood, that while an array of four contact receiving passageways 26 are shown here in FIG. 1, this array is extendable in both dimensions to form suitable sized arrays having a plurality of contact receiving passageways 26 in order to accomplish the number of electrical interconnections necessary for a particular application.

Next, the resilient contact 30 will be described in greater detail. The resilient contact 30 features a main body 36 which is located approximately in a central region of the contact 30. Extending outward from the main body 36 are a pair of resilient sections extending to contact sections 32, 34. In this exemplary embodiment, the main body 36 is a wound helical structure and the resilient sections are tapered helical structures continuously wound out from the main body 36. The contact section 32, extends beyond the first major surface 22 while the second contact section 34 extends beyond the second major surface 24. The contact 30 is secured within its respective contact receiving passageway 26 by solder or an interference or frictional fit between the main body 36 and the plated engagement section 27 of the carrier 20.

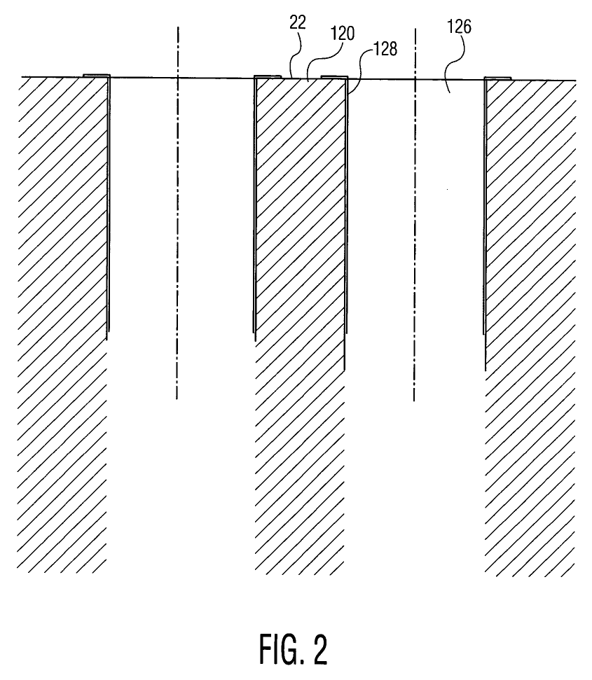

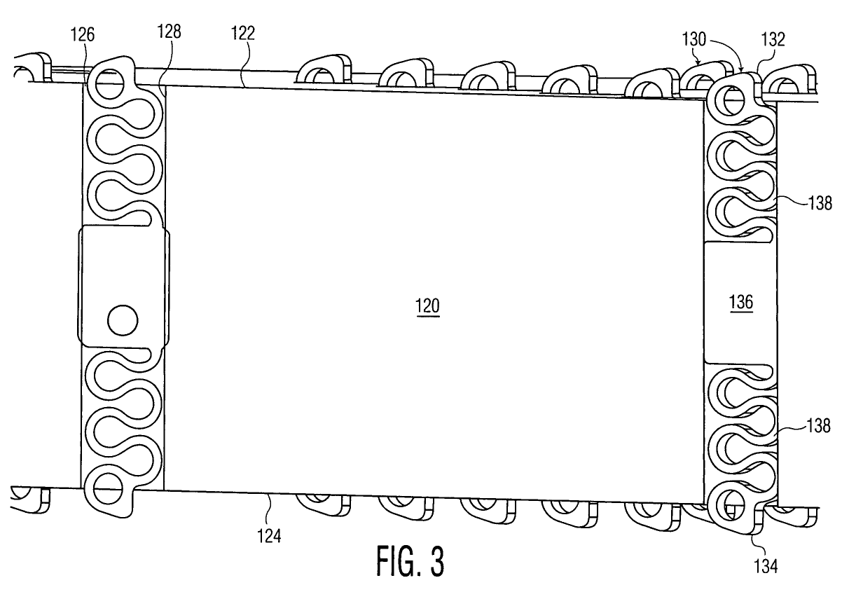

An alternate embodiment of the carrier 120 and an alternate contact 130 will be described now with reference to FIGS. 2 and 3. The carrier 120 is similar to the carrier 20 in that it has first and second major surfaces 122, 124 and a plurality of contact receiving passageways 126 that extend therebetween. Each contact receiving passageway 126 contains plating 128 applied to the surfaces of the contact receiving passageway 126 and portions of the first and second major surfaces 122, 124. The plating 128 is applied using well known techniques in the art for forming plated through holes in printed circuit boards. Each resilient contact 130 is similar to the resilient contact 30 in that it contains opposing contact sections 132, 134 which are located at free ends of resilient sections 138. A main body 136 is fixed within each contact receiving passageway 126 and is in electrical contact with plating 128. The resilient sections 138 that extend from the main body 136 are in the form of a serpentine spring. The main body 136, the resilient sections 138 and the contact portions 132, 134 are each formed of a simply stamped conductive sheet. The contact section 132 extends beyond the major surface 122 and the contact section 134 extends beyond the major surface 124 each for contacting lands or pads on respective circuits to be interconnected.

In operation, the land grid array connection 20, 120 allows current to pass between respective contact sections 32, 34, 132, 134 while the main body 36, 136 is in electrical contact with plating 28, 128 on the contact receiving passageways 26, 126. When circuits are energized, there is therefore no electrical potential difference between the resilient contact 30, 130 and its respective carrier 20, 120. Any electrical potential difference that may exist occurs between the plating 28, 128 and the carrier 20, 120. Accordingly, any relative motion caused by vibration or impact between the contact 30, 130 and the contact receiving passageway 26, 126 of the carrier 20, 120 will not cause any electron flow since no electrical potential or electron build up exist between the contact 30, 130 and the plating 28, 128. The undesirable effects of electron flow causing undesirable image patterns in medical imaging equipment is therefore minimized or eliminated.

The plating 28, 128 within the contact receiving passageways 26, 126 also serve as a conductive path for any signal passing through a respective contact 30,130. This has the advantageous effect of reducing the inductance of the interconnection across the contact 30, 130 and reduces the signal path length.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A land grid array connector comprising:
a carrier having a plurality of contact receiving passageways passing between two major surfaces thereof, each contact receiving passageway being plated over substantially the entire passageway between the two major surfaces and
resilient contacts located each within a respective contact receiving passageway and being in electrical contact with the plating such that ends of each resilient contact protrude out of the contact receiving passageway beyond each major surface of the carrier.

2. The land grid array connector of claim 1 wherein each resilient contact and is held frictionally within each plated contact receiving passageway.

3. The land grid array connector of claim 1 wherein each resilient contact and is soldered within each plated contact receiving passageway.

4. The land grid array connector of claim 2 wherein each resilient contact comprises a main body being in frictional contact with the plated contact receiving passageway and a pair of resilient sections extending to contact sections.

5. The land grid array connector of claim 4 wherein each main body is formed as a wound helical structure and each resilient section is formed as a tapered helical structure.

6. The land grid array connector of claim 4 wherein the contact sections each extend beyond respective major surfaces of the carrier.

7. The land grid array connector of claim 1 wherein plating extends over substantially the entire passageway and over portions of the two major surfaces

8. The land grid array connector of claim 4 wherein the resilient sections are serpentine springs.
